(19) United States
(12) Patent Application Publication
(10) Pub. No.: US 2005/0241750 A1
(43) Pub. Date: Nov. 3, 2005

(54) Method and apparatus for making extensible and stretchable laminates

(75) Inventors: Ann Louise McCormack, Cumming, GA (US); Robert David Wright, Peachtree City, GA (US); Michael Scotti, Appleton, WI (US); Richard J. Kamps, Wrightstown, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/836,052

(22) Filed: Apr. 30, 2004

(51) Int. Cl. B29C 31/00; B32B 31/00; B32B 1/00

(52) U.S. Cl. 156/229; 156/196; 156/443; 156/461

(57) ABSTRACT

A method of producing a stretchable laminate material by joining an incrementally stretched first sheet material to a second sheet material using a unitary device that both incrementally stretches the first sheet and maintains the deformation through lamination to the second sheet. The width of the first flexible sheet material is maintained through the incremental stretching to result in high efficiency of utilization of the first flexible sheet material in production of the laminate. The invention also provides a method for producing a laminate material by joining two simultaneously, incrementally stretched sheets to another sheet material using a unitary device that both incrementally stretches the two sheets and maintains the deformation of both sheets through lamination to the additional sheet. Also disclosed are the apparatus for producing such laminates.

### FIELD OF THE INVENTION

The present invention relates to methods for making extensible and stretchable laminates and apparatus for making of such extensible and stretchable laminates.

### BACKGROUND

Extensible and stretchable laminates are used in a wide variety of applications, not the least of which is as outercovers/backsheets for limited use or disposable products including personal care absorbent articles such as diapers, training pants, swimwear, incontinence garments, feminine hygiene products, wound dressings, bandages and the like. Extensible and stretchable laminates also have applications in the protective cover area, such as car, boat or other object cover components, tents (outdoor recreational covers), and in the health care area in conjunction with such products as surgical drapes, hospital gowns and fenestration reinforcements. Additionally, such materials have applications in other apparel for clean room, health care and other uses such as agricultural fabrics (row covers).

In the personal care area in particular, there has been an emphasis on the development of extensible film laminates which have good barrier properties, especially with respect to liquids, as well as good aesthetic and tactile properties such as hand and feel. There has been a further emphasis on the “stretch” comfort of such laminates, that is, the ability of the laminates to “give” as a result of the product utilizing such laminates being elongated in use. Extensible and stretchable material laminates have also been used in the personal care area to provide products with added elasticity and stretch to give the user desirable fit, comfort and/or fastening benefits.

Many such laminates used in consumer products are constructed with nonwoven facings which are necked (i.e., stretched in the machine direction and allowed to contract in width) and laminated to an extensible film. An example of this type of composite material is disclosed, for example, by U.S. Pat. No. 5,116,622 to Morman, issued Jul. 13, 1993. The necking of the nonwoven facing provides the laminate with cross-machine direction extensibility. A greater degree of necking in the nonwoven facings results in greater extensibility in the finished laminate. However, this necking of the facings reduces the base machine efficiency, as measured in square yards per hour. When facings are necked there is a corresponding loss of web width. This loss of width translates into an inefficient use of the full width of available nonwoven. A higher degree of necking of the nonwoven facing results in lower efficiency in machine width utilization.

It would therefore be desired to produce extensible or elastic laminates with more efficient use of nonwoven facings. It would also be desirable to reduce issues of handling grooved facings and product laminates in the most efficient use of machine space. The present invention addresses these and other opportunities for improvement.

### SUMMARY OF THE INVENTION

The present invention includes the use of a unitary device that provides multiple impact incremental stretching of a flexible sheet material and laminates the stretched sheet material to another flexible sheet material while making efficient use of the web width of the sheet material. Broadly, the invention includes three rolls that are configured and aligned such that a deformation nip is formed between a first roll and a second roll and a lamination nip is simultaneously formed between the second roll and a third roll. The first and second rolls are a pair of intermeshed grooved rolls. The rolls are configured and aligned such that material is deformed as it passed through the deformation nip and maintains its deformation as it passes through the lamination nip.

It is an embodiment of this invention that the first and second rolls are heated. Alternatively, the third roll may be heated. In other embodiments of the invention, the third roll may have a steel surface, a deformable surface, or may have a patterned surface. In a further embodiment, the third roll may have a deformable surface made of rubber.

In an alternate embodiment of the invention, the apparatus additionally includes a fourth roll which is placed in proximity to the first and second rolls and in working configuration with the third roll. In this embodiment, the third and fourth rolls are a pair of intermeshed grooved rolls that form a second deformation nip such that material that passes through this second deformation nip is deformed and maintains its deformation as it subsequently passes through the lamination nip formed by the second and third rolls.

In one embodiment of the invention having a fourth roll, the second and third rolls are capable of ultrasonic bonding. It is also possible that second and third are heated. Alternatively, the first and fourth rolls may be heated.

The invention also provides a method of using such an apparatus to produce a stretchable laminate including the steps of:
a. providing a first web, having a width;
b. providing a second web;
c. providing a first deforming nip, where the first deforming nip comprises a first roll and a second roll;
d. providing a laminating nip, where the laminating nip comprises a third roll and the second roll;
e. supplying the first web into the first deforming nip;
f. deforming the first web across its width, without reduction of the width, by stretching the first web while contacting the second roll;
g. supplying the deformed first web into the laminating nip;
h. supplying the second web to the laminating nip; and
i. joining the second web to the first web in the laminating nip.

The first web of the present invention may be a nonwoven material, such as a spunbond, or and absorbent material. In one embodiment, the first web is heated before it is supplied to the first deformation nip.

The second web may be an elastic film or an elastic nonwoven material. In one embodiment, the second web may be a breathable film. Alternatively, the second web may have multidirectional stretch properties. Additionally, the second web may be stretched before it is laminated to the first web.

In another embodiment the method for producing a stretchable laminate may include the additional steps of:
a. providing a third web, having a width;
b. providing a second deforming nip, where the second deforming nip comprises a fourth roll and the third roll;
c. supplying the third web in the first direction to the second deforming nip, where the first direction is also generally orthogonal to the width of the third web;
d. deforming the third web along its width, without reduction of the width, by stretching said third web while contacting the third roll;
e. supplying the deformed third web into the laminating nip;
f. joining the third web to the first web and the second web in the laminating nip.

One embodiment includes the additional step of heating the third web prior to supplying it to the second deformation nip.

The invention also includes an embodiment where the joining of the third web to the first and second webs in the laminating nip is accomplished using ultrasonic bonding.

### BRIEF DESCRIPTION OF THE DRAWINGS

FIG. 1 is a schematic illustration of an exemplary overall process and apparatus for deforming a flexible sheet material and laminating it to another flexible sheet material in accordance with present invention.

FIG. 2 is a representation of a cross-sectional view of an exemplary material laminate of the present invention

FIG. 3A is a schematic illustration of one embodiment of the process and apparatus for deforming a flexible sheet material and laminating it to another flexible sheet material where the deformation of the flexible material occurs in a single deformation nip.

FIG. 3B is a schematic illustration of another embodiment of the process and apparatus for deforming a flexible sheet material and laminating it to another flexible sheet material where the deformation of the flexible material occurs in a series of deformation nips.

FIG. 4 is a schematic illustration of an exemplary overall process and apparatus for simultaneously deforming two flexible sheet materials and laminating both of them to another flexible sheet material in accordance with present invention.

FIG. 5 is a representation of a cross-sectional view of an exemplary material laminate of the present invention.

FIG. 6A is schematic illustration of one embodiment of the process and apparatus for deforming two flexible sheet materials and laminating them to another flexible sheet material where the deformation of each of the flexible sheet materials occurs in single deformation nips.

FIG. 6B is a schematic illustration of one embodiment of the process and apparatus for deforming two flexible sheet materials and laminating them to another flexible sheet material where the deformation of each of the flexible sheet materials occurs in a series of deformation nips.

FIG. 7 is a representation of a perspective view of a grooved roll apparatus which may be used to stretch a flexible material layer in accordance with the invention.

FIG. 8 is a detailed partial, cross-sectional view of an engaged nip configuration such as shown in FIG. 7.

FIG. 9 is a representation of a perspective view of a grooved roll apparatus which may be used to stretch a two flexible material layers and bond the layers to a third layer in accordance with the invention.

FIG. 10 is a detailed partial, cross-sectional view of an engaged nip configuration and corresponding laminating nip configuration such as shown in FIG. 9.

FIG. 11 is a representation of a perspective view of a grooved roll apparatus along with a material feeder plate in accordance with the invention.

### DETAILED DESCRIPTION

Definitions

As used herein and in the claims, the term “comprising” is inclusive or open-ended and does not exclude additional unrecited elements, compositional components, or method steps.

As used herein, the term “personal care product” means generally absorbent products for use to absorb and/or dispose of bodily fluids, including but not limited to diapers, training pants, swimwear, absorbent underpants, adult incontinence products, and feminine hygiene products, such as feminine care pads, napkins and pantiliners. It also includes absorbent products for veterinary, medical and mortuary applications.

As used herein, the term “protective cover” means a cover for vehicles such as cars, trucks, boats, airplanes, motorcycles, bicycles, golf carts, etc., covers for equipment often left outdoors like grills, yard and garden equipment (mowers, rototillers, etc.) and lawn furniture, as well as floor coverings, table cloths and picnic area covers. It also includes covers for medical applications such as surgical drapes, gowns, etc.

As used herein the term “protective outer wear” means garments used for protection in the workplace, such as surgical gowns, hospital gowns, masks, and protective coveralls.

As used herein, the term “machine direction” or MD means the length of a web in the direction in which it is produced. The term “cross machine direction” or CD means the width of fabric, i.e. a direction generally perpendicular to the MD.

As used herein the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (g/m² or gsm) and the fiber diameters useful are usually expressed in microns. (Note that to convert from osy to gsm, multiply osy by 33.91).

As used herein the terms “sheet” and “sheet material” shall be interchangeable and in the absence of a word modifier, refer to woven materials, nonwoven webs, polymeric films, polymeric scrim-like materials, and polymeric foam sheeting.

As used herein the term “spunbond” refers to small diameter fibers which are formed by extruding molten thermoplastic material as filaments from a plurality of fine, usually circular capillaries of a spinneret with the diameter of the extruded filaments being rapidly reduced as by for example in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,542,615 to Dobo et al., which are each incorporated by reference in their entirety herein.

As used herein the term “meltblown” means fibers formed by extruding a molten thermoplastic material through a plurality of fine, usually circular die capillaries as molten threads or filaments into converging high velocity gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, in various patents and publications, including NRL Report 4364, “Manufacture of Super-Fine Organic Fibers” by B. A. Wendt, E. L. Boone and D. D. Fluharty; NRL Report 5265, “An Improved Device For The Formation of Super-Fine Thermoplastic Fibers” by K. D. Lawrence, R. T. Lukas, J. A. Young; and U.S. Pat. No. 3,849,241, issued Nov. 19, 1974, to Butin, et al

As used herein, the term “bonded carded webs” refers to webs that are made from staple fibers which are usually purchased in bales. The bales are placed in a fiberizing unit/picker which separates the fibers. Next, the fibers are sent through a combining or carding unit which further breaks apart and aligns the staple fibers in the machine direction so as to form a machine direction-oriented fibrous non-woven web. Once the web has been formed, it is then bonded by one or more of several bonding methods. One bonding method is powder bonding wherein a powdered adhesive is distributed throughout the web and then activated, usually by heating the web and adhesive with hot air. Another bonding method is pattern bonding wherein heated calender rolls or ultrasonic bonding equipment is used to bond the fibers together, usually in a localized bond pattern through the web and or alternatively the web may be bonded across its entire surface if so desired. When using bi-component staple fibers, through-air bonding equipment is, for many applications, especially advantageous.

As used herein, the term “coform” means a process in which at least one meltblown die head is arranged near a chute through which other materials are added to the web while it is forming. Such other materials may be pulp, superabsorbent particles, cellulose or staple fibers, for example. Coform processes are shown in U.S. Pat. No. 4,818,464 to Lau and U.S. Pat. No. 4,100,324 to Anderson et al., each incorporated by reference in its entirety.

As used herein “multilayer laminate” means a laminate wherein one or more of the layers may be spunbond and/or meltblown such as a spunbond/meltblown/spunbond (SMS) laminate and others as disclosed in U.S. Pat. No. 4,041,203 to Brock et al., U.S. Pat. No. 5,169,706 to Collier, et al, U.S. Pat. No. 5,145,727 to Potts et al., U.S. Pat. No. 5,178,931 to Perkins et al. and U.S. Pat. No. 5,188,885 to Timmons et al. Such a laminate may be made by sequentially depositing onto a moving forming belt first a spunbond fabric layer, then a meltblown fabric layer and last another spunbond layer and then bonding the laminate in a manner described below. Alternatively, the fabric layers may be made individually, collected in rolls, and combined in a separate bonding step. Such fabrics usually have a basis weight of from about 0.1 to 12 osy (6 to 400 gsm), or more particularly from about 0.40 to about 3 osy. Multilayer laminates for many applications also have one or more film layers which may take many different configurations and may include other materials like foams, tissues, woven or knitted webs and the like.

As used herein the term “laminate” refers to a composite structure of two or more sheet material layers that have been adhered through a bonding step, such as through adhesive bonding, thermal bonding, point bonding, pressure bonding, extrusion coating or ultrasonic bonding.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” includes all possible geometrical configurations of the molecule. These configurations include, but are not limited to isotactic, syndiotactic and random symmetries.

As used herein the term “monocomponent” fiber refers to a fiber formed from one or more extruders using only one polymer. This is not meant to exclude fibers formed from one polymer to which small amounts of additives have been added for color, antistatic properties, lubrication, hydrophilicity, etc. These additives, e.g. titanium dioxide for color, are generally present in an amount less than 5 weight percent and more typically about 2 weight percent.

As used herein the term “conjugate fibers” refers to fibers which have been formed from at least two polymers extruded from separate extruders but spun together to form one fiber. Conjugate fibers are also sometimes referred to as multicomponent or bicomponent fibers. The polymers are usually different from each other though conjugate fibers may be monocomponent fibers. The polymers are arranged in substantially constantly positioned distinct zones across the cross-section of the conjugate fibers and extend continuously along the length of the conjugate fibers. The configuration of such a conjugate fiber may be, for example, a sheath/core arrangement wherein one polymer is surrounded by another or may be a side by side arrangement, a pie arrangement or an “islands-in-the-sea” arrangement. Conjugate fibers are taught in U.S. Pat. No. 5,108,820 to Kaneko et al., U.S. Pat. No. 4,795,668 to Krueger et al., U.S. Pat. No. 5,540,992 to Marcher et al. and U.S. Pat. No. 5,336,552 to Strack et al. Conjugate fibers are also taught in U.S. Pat. No. 5,382,400 to Pike et al. and may be used to produce crimp in the fibers by using the differential rates of expansion and contraction of the two (or more) polymers. Crimped fibers may also be produced by mechanical means and by the process of German Patent DT 25 13 251 A1. For two component fibers, the polymers may be present in ratios of 75/25, 50/50, 25/75 or any other desired ratios. The fibers may also have shapes such as those described in U.S. Pat. No. 5,277,976 to Hogle et al., U.S. Pat. No. 5,466,410 to Hills and U.S. Pat. Nos. 5,069,970 and 5,057,368 to Largman et al., which describe fibers with unconventional shapes.

As used herein the term “biconstituent fibers” refers to fibers which have been formed from at least two polymers extruded from the same extruder as a blend. The term “blend” is defined below. Biconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Biconstituent fibers are sometimes also referred to as multiconstituent fibers. Fibers of this general type are discussed in, for example, U.S. Pat. Nos. 5,108,827 and 5,294,482 to Gessner. Bicomponent and biconstituent fibers are also discussed in the textbook Polymer Blends and Composites by John A. Manson and Leslie H. Sperling, copyright 1976 by Plenum Press, a division of Plenum Publishing Corporation of New York, IBSN 0-306-30831-2, at pages 273 through 277.

As used herein the term “blend” means a mixture of two or more polymers while the term “alloy” means a sub-class of blends wherein the components are immiscible but have been compatibilized. “Miscibility” and “immiscibility” are defined as blends having negative and positive values, respectively, for the free energy of mixing. Further, “compatibilization” is defined as the process of modifying the interfacial properties of an immiscible polymer blend in order to make an alloy.

As used herein, the term “bond” and derivatives does not exclude intervening layers between the bonded elements that are part of the bonded structure unless the text requires a different meaning.

As used herein the term “thermal point bonding” involves passing a fabric or web of fibers to be bonded between a heated calender roll and an anvil roll. The calender roll is usually, though not always, patterned in some way so that the entire fabric is not bonded across its entire surface, and the anvil roll is usually flat. As a result, various patterns for calender rolls have been developed for functional as well as aesthetic reasons. One example of a pattern has points and is the Hansen Pennings or “H&P” pattern with about a 30% bond area with about 200 bonds/square inch as taught in U.S. Pat. No. 3,855,046 to Hansen and Pennings, incorporated herein by reference in its entirety. The H&P pattern has square point or pin bonding areas wherein each pin has a side dimension of 0.038 inches (0.965 mm), a spacing of 0.070 inches (1.778 mm) between pins, and a depth of bonding of 0.023 inches (0.584 mm). The resulting pattern has a bonded area of about 29.5%. Another typical point bonding pattern is the expanded Hansen Pennings or “EHP” bond pattern which produces a 15% bond area with a square pin having a side dimension of 0.037 inches (0.94 mm), a pin spacing of 0.097 inches (2.464 mm) and a depth of 0.039 inches (0.991 mm). Another typical point bonding pattern designated “714” has square pin bonding areas wherein each pin has a side dimension of 0.023 inches, a spacing of 0.062 inches (1.575 mm) between pins, and a depth of bonding of 0.033 inches (0.838 mm). The resulting pattern has a bonded area of about 15%. Yet another common pattern is the C-Star pattern which has a bond area of about 16.9%. The C-Star pattern has a cross-directional bar or “corduroy” design interrupted by shooting stars. Other common patterns include a diamond pattern with repeating and slightly offset diamonds with about a 16% bond area and a wire weave pattern looking as the name suggests, e.g. like a window screen pattern having a bond area in the range of from about 15% to about 21% and about 302 bonds per square inch. Typically, the percent bonding area varies from around 10% to around 30% of the area of the fabric laminate web. As is well known in the art, the spot bonding holds the laminate layers together as well as imparts integrity to each individual layer by bonding filaments and/or fibers within each layer.

As used herein, the term “ultrasonic bonding” means a process performed, for example, by passing the fabric between a sonic horn and anvil roll as illustrated in U.S. Pat. No. 4,374,888 to Bornslaeger, incorporated by reference herein in its entirety.

As used herein, the term “adhesive bonding” means a bonding process which forms a bond by application of an adhesive. Such application of adhesive may be by various processes such as slot coating, spray coating and other topical applications. Further, such adhesive may be applied within a product component and then exposed to heat and/or pressure such that contact of a second product component with the adhesive containing product component forms an adhesive bond between the two components.

As used herein, the term “elastomeric” shall be interchangeable with the term “elastic” and refers to material which, upon application of a stretching force, is stretchable in at least one direction (such as the CD direction), and which upon release of the stretching force contracts/returns to approximately its original dimension. For example, a stretched material having a stretched length which is at least 50 percent greater than its relaxed unstretched length, and which will recover to within at least 50 percent of its stretched length upon release of the stretching force. A hypothetical example would be a one (1) inch sample of a sheet material which is stretchable to at least 1.50 inches and which, upon release of the stretching force, will recover to a length of not more than 1.25 inches. Desirably, such elastomeric sheet contracts or recovers up to 50 percent of the stretch length in the cross machine direction using a cycle test as described herein to determine percent set. Even more desirably, such elastomeric sheet material recovers up to 80 percent of the stretch length in the cross machine direction using a cycle test as described. Even more desirably, such elastomeric sheet material recovers greater than 80 percent of the stretch length in the cross machine direction using a cycle test as described. Desirably, such elastomeric sheet is stretchable and recoverable in both the MD and CD directions. For the purposes of this application, values of load loss and other “elastomeric functionality testing” have been generally measured in the CD direction, unless otherwise noted. Unless otherwise noted, such test values have been measured at the 50 percent elongation point of a 70 percent total elongation cycle.

As used herein, the term “elastomer” shall refer to a polymer which is elastomeric.

As used herein, the term “thermoplastic” shall refer to a polymer which is capable of being melt processed.

As used herein, the term “inelastic” or “nonelastic” refers to any material which does not fall within the definition of “elastic” above.

As used herein the terms “recover”, “recovery” and “recovered” shall be used interchangeably and shall refer to a contraction (retraction) of a stretched material upon termination of a stretching force following stretching of the material by application of the stretching force. For example, if a material having a relaxed, unstretched length of 1 inch (2.5 cm) is elongated fifty percent by stretching to a length of 1.5 inches (3.75 cm), the material would be elongated 50 percent and would have a stretched length that is 150 percent of its relaxed length or stretched 1.5× (times). If this exemplary stretched material contracted, that is recovered to a length of 1.1 inches (2.75 cm) after release of the stretching force, the material would have recovered 80 percent of its 0.5 inch (1.25 cm) elongation. Percent recovery may be expressed as [(maximum stretch length-final sample length)/(maximum stretch length−initial sample length)]×100.

As used herein the term “extensible” means elongatable in at least one direction, but not necessarily recoverable.

As used herein the term “monolithic” is used to mean “non-porous”, therefore a monolithic film is a non-porous film. Rather than holes produced by a physical processing of the monolithic film, the film has passages with cross-sectional sizes on a molecular scale formed by a polymerization process. The passages serve as conduits by which water molecules (or other liquid molecules) can disseminate through the film. Vapor transmission occurs through a monolithic film as a result of a concentration gradient across the monolithic film. This process is referred to as activated diffusion. As water (or other liquid) evaporates on the body side of the film, the concentration of water vapor increases. The water vapor condenses and solubilizes on the surface of the body side of the film. As a liquid, the water molecules dissolve into the film. The water molecules then diffuse through the monolithic film and re-evaporate into the air on the side having a lower water vapor concentration.

As used herein, the term “microporous film” or “microporous filled film” means films which contain filler material which enables development or formation of micropores in the film during stretching or orientation of the film.

As used herein, “filler” is meant to include particulates and/or other forms of materials which can be added to a film polymer extrusion material which will not chemically interfere with or adversely affect the extruded film and further which are capable of being dispersed throughout the film. Generally the fillers will be in particulate form with average particle sizes in the range of about 0.1 to about 10 microns, desirably from about 0.1 to about 4 microns. As used herein, the term “particle size” describes the largest dimension or length of the filler particle.

As used herein, the term “breathable” refers to a material which is permeable to water vapor. The water vapor transmission rate (WVTR) or moisture vapor transfer rate (MVTR) is measured in grams per square meter per 24 hours, and shall be considered equivalent indicators of breathability. The test is conducted at body temperature (37° C.). The WVTR of a material can be measured in accordance with ASTM Standard E96-80. Alternatively, for materials having WVTR greater than about 3000 g/m2/24 hours testing systems such as, for example, the PERMATRAN-W 100K water vapor permeation analysis system, commercially available from Modern Controls, Inc. (MOCON) of Minneapolis, Minn., may be used. The term “breathable” desirably refers to a material which is permeable to water vapor having a minimum WVTR (water vapor transmission rate) of desirably about 300 g/m²/24 hours. Even more desirably, such material demonstrates breathability greater than about 1500 g/m²/24 hours. Still even more desirably, such material demonstrates breathability greater than about 3000 g/m²/24 hours. The WVTR of a fabric, in one aspect, gives an indication of how comfortable a fabric would be to wear. WVTR is measured as indicated below. Often, personal care product applications of breathable barriers desirably have higher WVTRs and breathable barriers of the present invention can have WVTRs exceeding about 1,200 g/m²/24 hours, 1,500 g/m²/24 hours, 1,800 g/m²/24 hours or even exceeding 2,000 g/m²/24 hours.

Unless otherwise indicated, percentages of components in formulations are by weight.

### DESCRIPTION

The present invention relates to a method and apparatus for the formation of a laminate from flexible sheet materials. The flexible sheet materials of the present invention are such that when used in a laminate will provide the desired barrier, aesthetic, tactile and/or extensibility properties.

One such flexible sheet material that can be used are nonwoven webs. Nonwoven web materials suitable for use in the method of this invention may be, for example, selected from the group consisting of spunbond, meltblown, spunbond-meltblown-spunbond laminates, coform, spunbond-film-spunbond laminates, bicomponent spunbond, bicomponent meltblown, biconstituent spunbond, biconstituent meltblown, bonded carded web, airlaid and combinations thereof.

The nonwoven web materials are preferably formed with polymers selected from the group including polyolefins, polyamides, polyesters, polycarbonates, polystyrenes, thermoplastic elastomers, fluoropolymers, vinyl polymers, and blends and copolymers thereof. Suitable polyolefins include, but are not limited to, polyethylene, polypropylene, polybutylene, and the like; suitable polyamides include, but are not limited to, nylon 6, nylon 6/6, nylon 10, nylon 12 and the like; and suitable polyesters include, but are not limited to, polyethylene terephthalate, polybutylene terephthalate and the like. Particularly suitable polymers for use in the present invention are polyolefins including polyethylene, for example, linear low density polyethylene, low density polyethylene, medium density polyethylene, high density polyethylene and blends thereof; polypropylene; polybutylene and copolymers as well as blends thereof. Additionally, the suitable fiber forming polymers may have thermoplastic elastomers blended therein.

Nonwoven fabrics which are used in such laminates, prior to conversion into such laminates, desirably have a basis weight between about 10 g/m² and 50 g/m² and even more desirably between about 12 g/m² and 25 g/m². In an alternative embodiment such nonwoven fabrics have a basis weight between about 15 g/m² and 20 g/m².

Another flexible sheet material used is polymeric films. Such polymeric films provide a barrier to fluids while remaining flexible and can be apertured, slit, filled, monolithic, breathable, extensible, stretchable or combinations thereof. Examples of such films are described in WO 96/19346 to McCormack et al. and in U.S. patent application Ser. No. 10/703,761 titled Microporous Breathable Elastic Films, Methods Of Making Same, And Limited Use Or Disposable Product Applications, to McCormack et al. filed Nov. 7, 2003, each of which is incorporated herein by reference in its entirety.

Other possible flexible sheet materials may include but are not limited to absorbent webs and webs of elastomeric filaments.

While it should be recognized that flexible sheet materials can be chosen from a broad spectrum of materials, nonwoven webs and polymeric films are used hereunder for illustrative purposes.

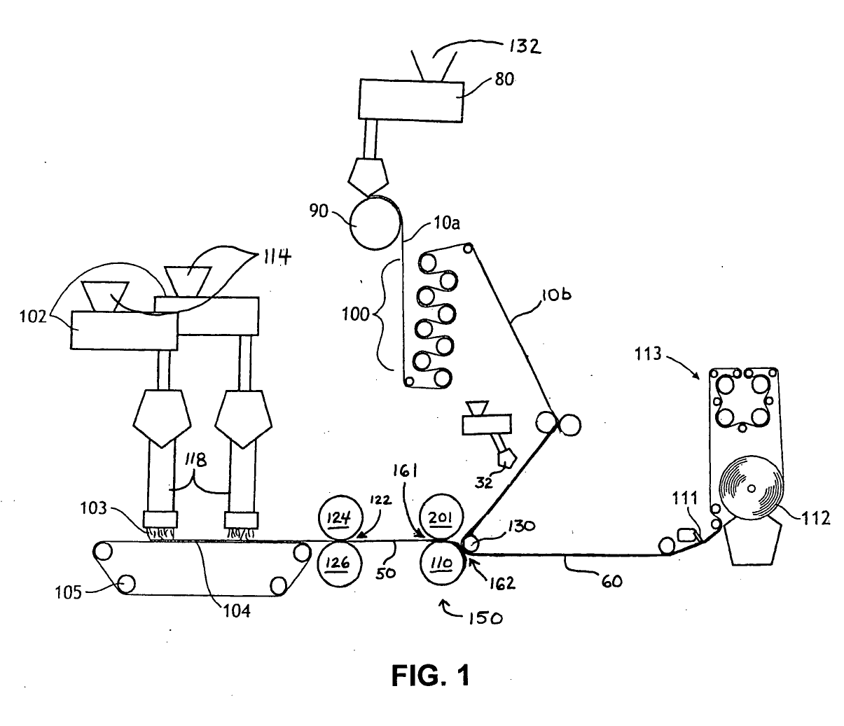

FIG. 1 is a schematic illustration of a process incorporating the stretching and lamination process and apparatus of the present invention. Specifically, FIG. 1 illustrates a process for incrementally stretching a nonwoven web and laminating it to a polymeric film. As shown, a nonwoven web 50 is formed by feeding extruders 102 from polymer hoppers 114 and forming continuous filaments 103 from filament formers 118 onto web former 104. The resulting web 50 is bonded at calender nip 122 formed by a patterned roll 124 and anvil roll 126, one or both of which may be heated to a thermal bonding temperature. After bonding, web 50 is incrementally stretched in accordance with the invention using the deformation and lamination unit 150 having a grooved anvil roll 110, a second grooved anvil roll 201, and a lamination roll 130. The grooved anvil roll and the second grooved roll 201 are adjacent to one another and form a deformation nip 161 therebetween, in which the web 50 is incrementally stretched.

Film 10a is formed by feeding extruder 80 from polymer hopper 132 and casting onto a roll 90. The film 10a is stretched by a machine direction orienter (MDO) 100 and adhesive is applied to the stretched film 10b at the adhesive station 32. The stretched film 10b and the stretched nonwoven are combined at the laminating nip 162 between the grooved anvil roll 110 and the lamination roll 130. The laminate 60 is then directed to a slitter 111, if slitting is desired, and to temperature controlled section 113 to retract and/or anneal and chill, as desired. Finally, the laminate is directed to winder 112 or, optionally, directed to further processing. Also, stretching of one or more of the component layers individually and as a laminate may be carried out in accordance with the invention.

FIG. 1 illustrates a process where both the film and the nonwoven are produced in-line with the remainder of the deformation and laminating process. Alternatively, the film and/or the nonwoven may be provided to the deformation and laminating process as pre-formed material rolls.

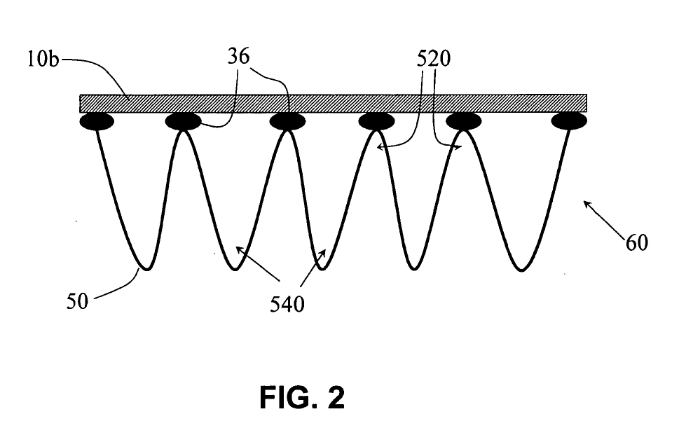

FIG. 2 is a representation of a cross-sectional view of the material laminate produced by the inventive method as illustrated in FIG. 1. When the nonwoven material 50 is stretched by the deformation and lamination unit 150, the corrugated surface of the nonwoven material 50 will be made up of a series of alternating surface contacting peaks 520 and recessed troughs 540 between the peaks 520. Ideally, the nonwoven material 50 will be attached to the film material 10b with the adhesive 36 only at the discrete points where the peaks 520 of the nonwoven material 50 contact the film material 10b.

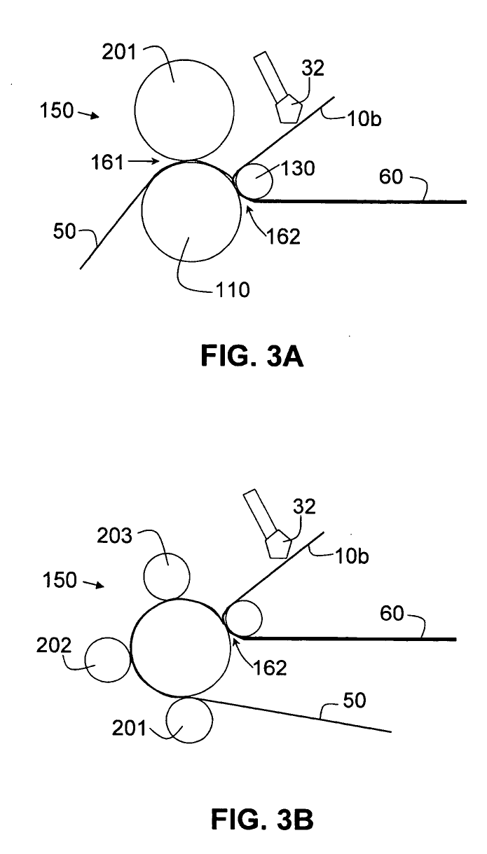

The groove roll arrangement of the inventive method may be single rolls immediately adjacent to one another such that the peaks of one roll lie in the valleys of an adjacent roll (as depicted in FIG. 1), or alternatively, they may be a single or main anvil roll that is encircled by smaller satellite rolls. FIG. 1 and FIG. 3A shows a deformation and lamination apparatus 150 that uses single rolls 201, 110 immediately adjacent to one another which deform the nonwoven material 50 in a deformation nip 161. Alternatively, as shown in FIG. 3B, the nonwoven material 50 may be coursed through a grooved roll arrangement in which a main anvil roll 110 is encircled on its periphery by one or more satellite rolls 201, 202, 203.

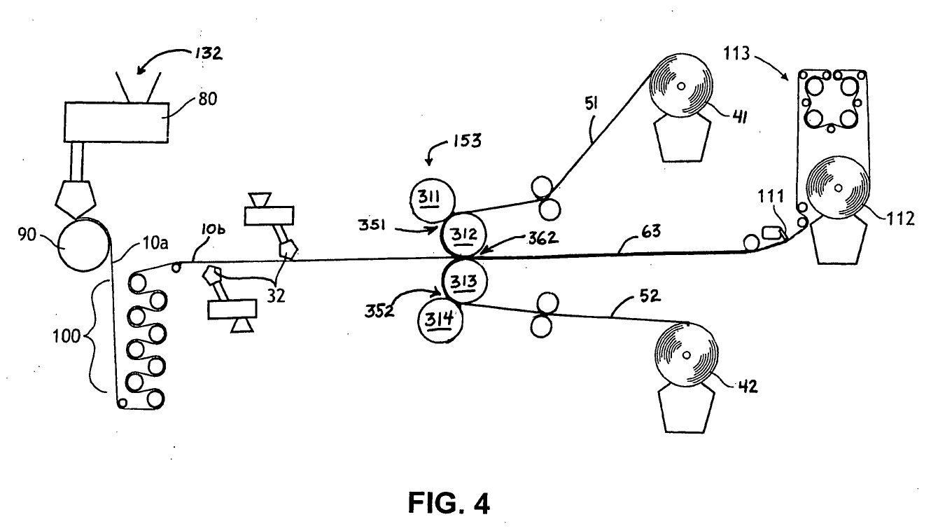

FIG. 4 is a schematic illustration of a laminating process and incorporates the stretch and lamination process and apparatus of the present invention. Specifically, FIG. 4 illustrates a process for deforming two nonwoven webs and laminating them to a polymeric film. As shown, the nonwoven webs 51 and 52 are unwound from two unwind stations 41 and 42. The nonwoven webs 51, 52 are incrementally stretched using the deformation and lamination unit 153 having two grooved anvil rolls 312, 313, two additional grooved rolls 311, 314, and a lamination nip 362 formed between the two grooved anvil rolls 312, 313. Each anvil roll 312, 313 is adjacent to one of the additional grooved rolls 311, 314 such that a pair of deformation nips 351, 352 are formed therebetween in which the nonwoven webs 51, 52 are incrementally stretched.

Film 10a is formed by feeding extruder 80 from polymer hopper 132 and casting onto a roll 90. The film 10a is stretched by a MDO 100 and adhesive is applied to both surfaces of the stretched film 10b at adhesive stations 32. The stretched film 10b and the stretched nonwovens are combined at the laminating nip 362 between the two grooved anvil rolls 312, 313. The laminate 63 is then directed to a slitter 111, if slitting is desired, and to a temperature controlled section 113 to retract, and/or anneal and chill, as desired. Finally, the laminate 63 is directed to winder 112 or, optionally, directed to further processing.

FIG. 4 illustrates a process where the film is produced in-line with the rest of the lamination process and the nonwoven webs are unwound from rolls provided to the process. Alternatively, any of the materials can be produced in-line with the rest of the lamination process, provided to the process on pre-formed rolls, or any combination of in-line production and provided rolls.

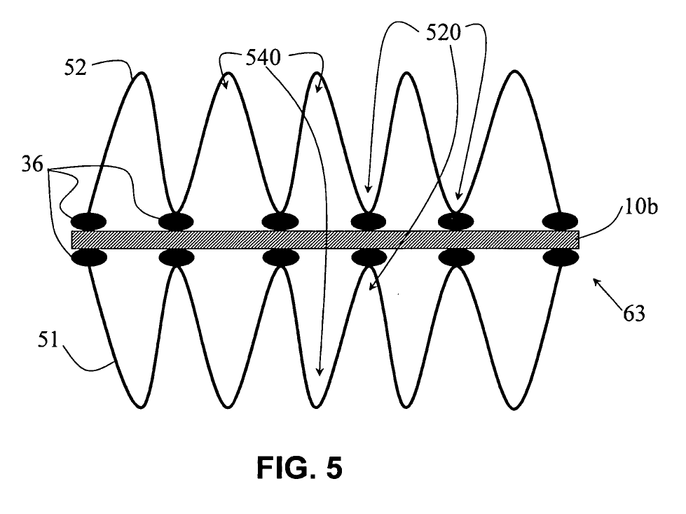

FIG. 5 is a representation of a cross-sectional view of the material laminate produced by the inventive method as illustrated in FIG. 4. When the nonwoven webs 51, 52 are stretched by the deformation and lamination unit 153, the corrugated surfaces of the nonwoven webs 51, 52 will be made up of a series of alternating surface contacting peaks 520 and recessed troughs 540 between the peaks 520. Ideally, the nonwoven webs 51, 52 will be attached to the film material 10b with the adhesive 36 only at the discrete points where the peaks 520 of the nonwoven webs 51, 52 contact the film material 10b.

As in the process and apparatus illustrated in FIGS. 1, 2A and 2B, the deformation of the two nonwoven webs, as shown in FIG. 4, can be achieved using two single sets of adjacently intermeshed rolls (as shown in FIG. 4) or, alternatively, using two anvil rolls each surrounded by a set of smaller satellite rolls.

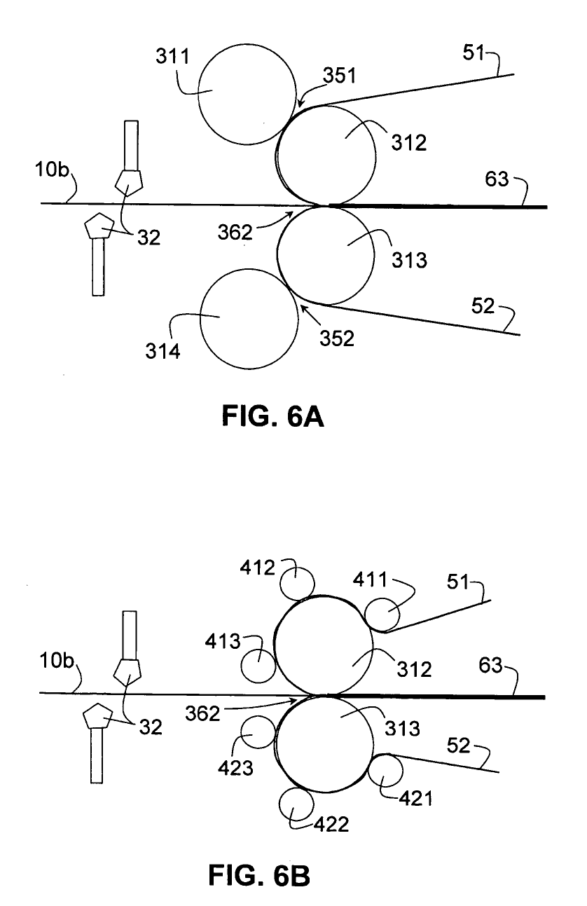

FIG. 6A and FIG. 4 illustrate the deformation of the nonwoven webs 51, 52 using pairs of adjacent grooved rolls 311, 312 and 313, 314. The first nonwoven web 51 is deformed in a first deformation nip 351 between two grooved rolls 311, 312. A second nonwoven web 52 is deformed in a second deformation nip 352 between another set of grooved rolls 313, 314. Additionally, the rolls that make up the first and second deformation nips 351, 352 are configured in proximity to each other such that a lamination nip 362 is formed between one of the rolls making up the first deformation nip 351 and one of the rolls making up the second deformation nip 352.

Alternatively, FIG. 6B illustrates a deformation and lamination apparatus that employs deformation nips comprising single anvil rolls 312, 313 with sets of smaller satellite rolls 411, 412, 413 and 421, 422, 423 to deform the nonwoven webs 51, 52. These sets of deformation apparatus are configured in proximity to one another such that a lamination nip 362 is formed between the two anvil rolls 312, 313.

The rolls of the apparatus, as illustrated in FIGS. 1, 3A, 3B, 4, 6A and 6B, may be constructed of steel or other materials satisfactory for the intended use conditions as will be apparent to those skilled in the art. Also, it is not necessary that the same material be used for all the rolls. The anvil roll, for example, may be constructed of hard rubber or other more resilient material so as to impart less stressful conditions on the flexible web. Additionally, the rolls may be heated electrically or the roll may have double shell construction to allow a heating fluid such as a mixture of ethylene glycol and water to be pumped through the roll and provide a heated surface.

As discussed above, the deformation of the nonwoven web(s) is accomplished using intermeshed grooved rolls. Additionally, as shown in FIGS. 2B and 4B, the deformation is accomplished using grooved anvil rolls surrounded by a set of satellite grooved rolls. A device for stretching such fabrics is described in US application bearing Attorney Docket Number 19078 PCT, Serial Number PCT/US03/26247 titled Multiple Impact Device and Method for Treating Flexible Webs, to Robert James Gerndt et al. filed Aug. 22, 2003. Such application is incorporated by reference hereto in its entirety.

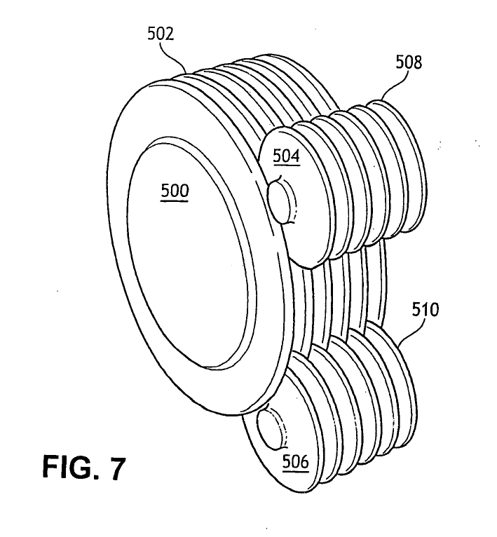

FIG. 7 is a representation of a perspective view of a grooved anvil with satellite groove rolls. As can be seen in FIG. 7, an anvil roll includes about its periphery a series of grooves in the anvil and satellite rolls which run concentrically around the rolls and, therefore, the web is stretched in the widthwise or cross machine direction. The grooves of such grooved rolls may be grooves machined into a roll, may be series of elements such as discs, or may be any other means that provides the functional structure shown. As shown, anvil roll 500 includes grooves 502 and is positioned in working engagement with satellite rolls 504, 506, also having grooves 508 and 510, respectively. It will be apparent that the number of engaging rolls and the engagement depth of the respective rolls may be varied, and the rolls may be partially or fully grooved to provide zoned or full stretching along the roll length as desired. The rolls are desirably driven at speeds matched to the desired effective engagement by one or more motors (not shown).

As shown in FIG. 7, the anvil roll 500 is engaged by satellite rolls 504 and 506 which operate to apply a stretching force to a material web as the material web passes through each of the nips formed between the anvil and satellite rolls. In this case, the grooves of one of the satellite rolls extend into mating grooves of the anvil roll to a lesser extent than do the grooves of the other satellite roll. In this manner, stretching forces applied to the material web may be gradually increased so that there is a reduced tendency to tear or otherwise damage the material web and yet stretch to a high degree. It will be apparent that varying the mating engagement of the rolls in this manner may be done with any or all of the satellite rolls and may occur in any order of increasing or decreasing engagement as desired.

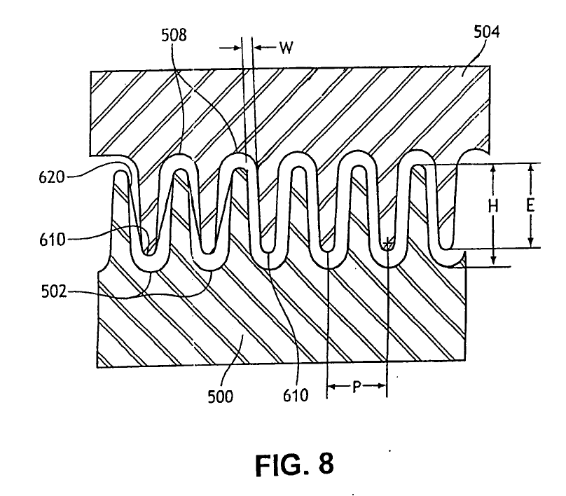

FIG. 8 is an enlarged partial cross sectional view of an engaged deformation nip, for example, for the embodiment of FIG. 7 showing a portion of the width of the web 620, where the web 620 is traveling out of the plane of the page toward the viewer. While, for purposes of more clearly illustrating the nip, the portion of the width of the web 620 is only shown partially across the nip, it will be apparent that the web may and will normally extend completely across the nip. As shown, the grooves 502 of anvil roll 500 intermesh or accommodate the fins 610 between the grooves 508 of satellite roll 504. The intermeshing, in this case, maintains spacing, W, between the respective groove walls that is wider than the thickness of web 620 with the result that the web is generally stretched without being compressed. As shown, H measures the wall height, and E measures the depth of engagement. The number of grooves per inch, N, is measured by counting the number of walls, tip to tip, per inch along the roll, sometimes also called “pitch”.

The number of grooves may be varied widely to achieve desired results. For example, for stretching of lightweight laminates of film and nonwoven for disposable personal care product applications such as a backing/outercover component, the number of grooves useful may vary from about 3 to about 15 per inch, although greater or fewer are contemplated. For instance, in one particular embodiment, the number of grooves is between about 5 and 12 grooves per inch. In a further alternative embodiment, the number of grooves is between 5 and 10 per inch. Essentially, in one particular embodiment, the peak to peak distance of the fins, shown as length P in FIG. 8, may be varied from about 0.333 inch to about 0.0666 inch. In an alternative embodiment the peak to peak distance may be between about 0.200 inch to about 0.083 inch. The engagement of the fins and grooves of the grooved rolls may be from about 0 to 0.300 inch. In an alternative embodiment, the engagement of fins in grooves is between about 0.010 inch to about 0.200 inch. In another embodiment, the engagement may be between about 0.070 inch to about 0.150 inch. Desirably, in one embodiment the total stretch of the material in the CD direction is between about 2.0-2.75× and an engagement of between about 0.100 inch to about 0.150 inch (at about 8 grooves per inch). Such conditions are desirable for a prelamination stretching of a nonwoven material prior to lamination to a film. For such applications, it may be important that the compression of the material be avoided, and the shape of the intermeshing grooves may be selected for that purpose. Furthermore, the depth of engagement as the grooves intermesh may also be varied so as to achieve the desired stretch level. It is a feature of the present invention that high stretch levels may be attained in localized areas in steps of engagement that avoid single, harsh impact that might damage fragile materials.

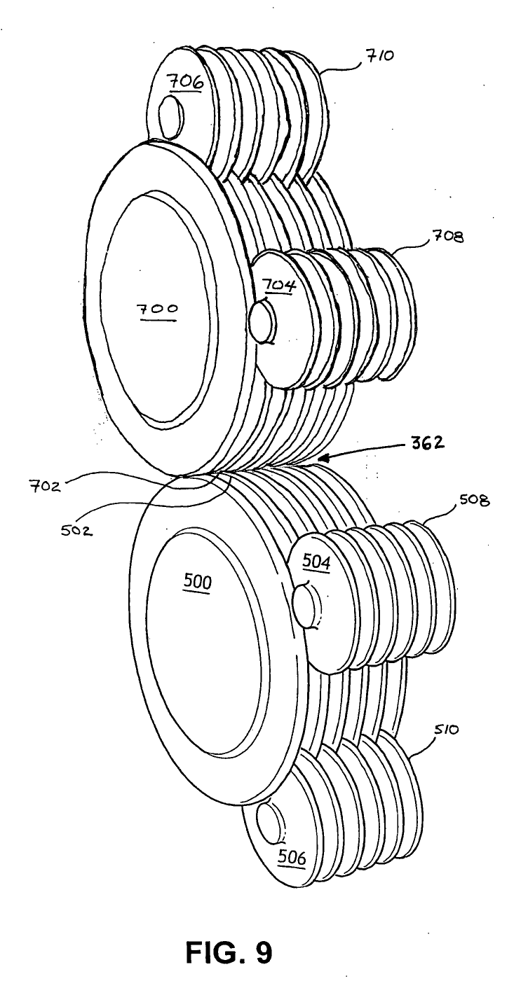

FIG. 9 illustrates a deformation roll apparatus much like that shown in FIG. 7, but FIG. 9 shows the embodiment having two anvil rolls forming a lamination nip therebetween. Both anvil rolls include about their respective peripheries a series of grooves in the anvils and satellite rolls which run concentrically around the rolls, and therefore, the webs are stretched in the width-wise or cross-machine direction. As shown, a first anvil roll 500 includes grooves 502 and is positioned in working engagement with satellite rolls 504, 506, also having grooves 508 and 510, respectively. The second anvil roll 700 also includes grooves 702 and is positioned in working engagement with satellite rolls 704, 706, also having grooves 708 and 710 respectively. It will be apparent that the number of engaging rolls and the engagement depth of the respective rolls may be varied, and the rolls may be partially or fully grooved to provide zoned or full stretching along the roll length as desired. The rolls are desirably driven at speeds matched to the desired effective engagement by one or more motors (not shown).

As discussed above, the first anvil roll 500 is engaged by satellite rolls 504 and 506 which operate to apply a stretching force to a first material web as the material web passes through each of the nips formed between the first anvil 500 and its satellite rolls 504, 506. Likewise, the second anvil roll 700 is engaged by satellite rolls 704 and 706 which operate to apply a stretching force to a second material web as the second material web passes through each of the nips formed between the second anvil 700 and its satellite rolls 704, 706. As discussed above, it will be apparent that varying the mating engagement of the rolls in this manner may be done with any or all of the satellite rolls and may occur in any order of increasing or decreasing engagement as desired.

Additionally, the anvil rolls 500 and 700 are positioned and aligned in proximity to each other to form the lamination nip 362 therebetween. As shown, the lamination nip 362 is a series of nips formed by the proximity of the grooves 502 of the first anvil roll 500 and the grooves 702 of the second anvil roll 700.

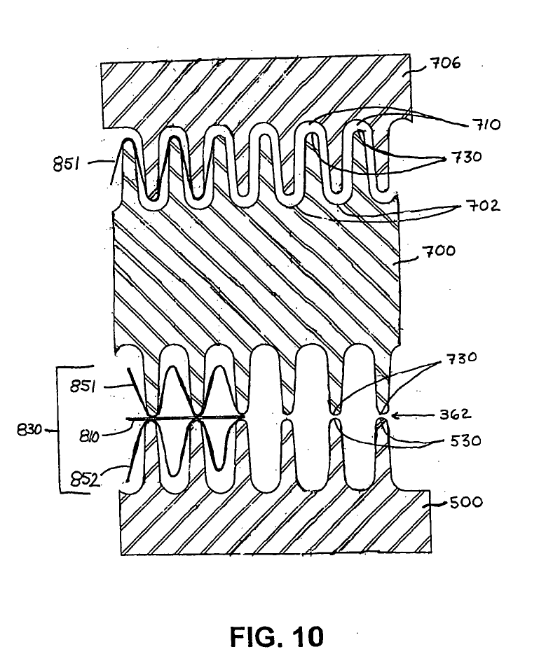

FIG. 10 is an enlarged partial cross-sectional view of an engaged deformation nip and corresponding lamination nip, for example, for the embodiment of FIG. 9. For the purposes of showing how each anvil roll simultaneously deforms a material web in a deformation nip and laminates that deformed material web to another material web in the lamination nip, only the second anvil roll 700, a portion of a satellite roll 706, and a portion of the first anvil roll 500 are shown in cross sectional view. The illustrated rolls are viewed in the plane of web travel such that the deformed material web 851 would travel out of the plane of the page toward the viewer and the laminate web 830 would travel into the plane of the page away from the viewer. While neither the entire first anvil roll 500 nor its corresponding satellite rolls 506 are shown in FIG. 10 (as they were illustrated in FIG. 9), such rolls would be configured and operate in the same manner as for the rolls that actually illustrated in FIG. 10.

The engaged deformation nip between the second anvil roll 700 and one of the satellite rolls 706 is illustrated toward the top of FIG. 10 and shows a portion of the width of the first material web 851. While, for purposes of more clearly illustrating the nip, the portion of the width of the first material web 851 is only shown partially across the nip, it will be apparent that the web will normally extend completely across the nip. As discussed above in FIG. 8, the grooves 702 of anvil roll 700 intermesh or accommodate the fins 730 between the grooves 710 of satellite roll 706. The nip and the dimensions of grooves and engagement will be the same as discussed above for the nip shown in FIG. 8. The depth of engagement as the grooves intermesh may be varied to achieve the desired incremental stretch level for the first material web 851.

FIG. 10 also shows the lamination nip 362 and a portion of the width of the laminate web 830. The laminate web 830 is comprised of the deformed first material web 851, the second material 810, and the deformed third material web 852. The deformed first material web 851, which was incrementally stretched in the deformation nip (shown at the top of FIG. 10), travels out of the plane of the page toward the viewer. The deformed first material web 851 follows, and stays in contact with, the surface (not shown) of the anvil roll 700. The first material web 851 then enters the lamination nip 363 where it is laminated to the second material 810 and the deformed third material web 852.

The finished laminate web 830 then proceeds into the plane of the page, away from the viewer. While, for purposes of more clearly illustrating the nip, the portion of the width of the laminate web 830 is only shown partially across the lamination nip, it will be apparent that the web will normally extend completely across the nip.

In addition to increasing the desired stretch level through increased engagement of the grooved rolls, the effectiveness of the use of grooved rolls can be increased through control of the tension of the nonwoven web as well as by heating the nonwoven web and the grooved rolls. This effectiveness can be seen in the amount of incremental cross-machine direction stretch found when all other parameters are held constant. Tension and heat can be adjusted to provide incremental increases to the overall all level of incremental stretch that is imparted to the nonwoven web.

By maintaining machine direction tension of the nonwoven web as the nonwoven web passes through the grooved roll apparatus, the effectiveness of the incremental cross-machine direction stretch is increased. When there is slack in the nonwoven web the web can freely move across its width to some degree. Thus, rather than fully stretching between the ridges of the fins of the grooved rolls, the nonwoven web “slips” between those same ridges. In other words, the width of the nonwoven web decreases as the web “slips” to conform to the contours of the surfaces of the grooved rollers.

When tension is maintained in the machine direction of the nonwoven web, the web will have less ability to “slip” in the cross-machine direction. The tension in the machine direction can be maintained with the use of an S-wrap place in the web path prior to the grooved roll apparatus and/or through the use of tension unwinds. When tension is maintained the nonwoven web then can be incrementally stretched to greater degree between the ridges of the fins of the grooved rolls than when the nonwoven web is not held in tension. With higher levels of web tension, the incremental cross-machine stretching will become more effective.

Preheating the nonwoven web prior to entering the grooved roll apparatus and heating the grooved rolls will increase the effectiveness of the grooved rolls in stretching the nonwoven web. By heating the nonwoven web and the grooved rolls, the modulus of the web can be reduced and thus increase the ease of incremental cross-machine stretching. The nonwoven web can be heated with the use of a hot air knife or any other similar device as known in the art for heating material webs. Generally, the nonwoven web will be heated with air that is 120° F. to 250° F. Similarly, the grooved rolls are heated to a temperature of 120° F. to 250° F.

In making the extensible or stretchable laminate of the present invention, the use of a nonwoven web that has been grooved rather than using necked nonwoven facings provides for greater machine utilization efficiencies. The extensibility of laminates produced with grooved nonwoven depends on the degree that the nonwoven facing is grooved. Through control of web tension, the width of the grooved nonwoven exiting the grooved roll apparatus can be maintained to the same width of the nonwoven that enters the grooved roll apparatus. Therefore, the grooved material can have a high degree of cross-machine direction extensibility while fully maintaining web width and thus maximizing the utilization of material web width.

Additionally, the effect of grooving can be enhanced by necking the grooved nonwoven facings after the grooved roll apparatus and prior to lamination. If the grooved nonwoven is necked, less necking is needed to achieve the same level of extensibility as by necking alone because some of the extensibility is delivered by the incremental cross-machine direction stretch imparted by grooving the material. As less necking is required of a grooved nonwoven versus a non-grooved nonwoven, there will be a smaller resultant reduction of web width to achieve the same resultant level of extensibility. Thus, for the same level of extensibility, a better efficiency of machine width utilization can be found with the use of grooved nonwoven facings that have been necked than can be found with necked nonwoven facings.

One issue with the use of grooved nonwoven webs is the durability and integrity of nonwoven webs that have been stretched by high levels of engagement of the grooved rolls. Higher levels of engagement can mean a lower durability and integrity in the resultant grooved nonwoven web. The high degree of stretching softens the web and breaks fiber bonds of the nonwoven web. Decreasing the level of engagement of the grooved rollers can increase integrity and durability, but also results in the decrease in the amount of the incremental cross-machine stretch and thus decreases the amount of available extensibility (or stretchability) in the final extensible (or stretchable) laminate. However, the integrity and durability of the web and the amount of extensibility/stretchability can be balanced with necking the grooved nonwoven web to some degree prior to attachment to the polymeric film. As discussed above, necking the grooved nonwoven web will decrease the efficiency of the utilization of width. In the end, however, efficiency of web width utilization is balanced with the need for available cross-machine extensibility/stretchability and desired level of nonwoven integrity and durability.

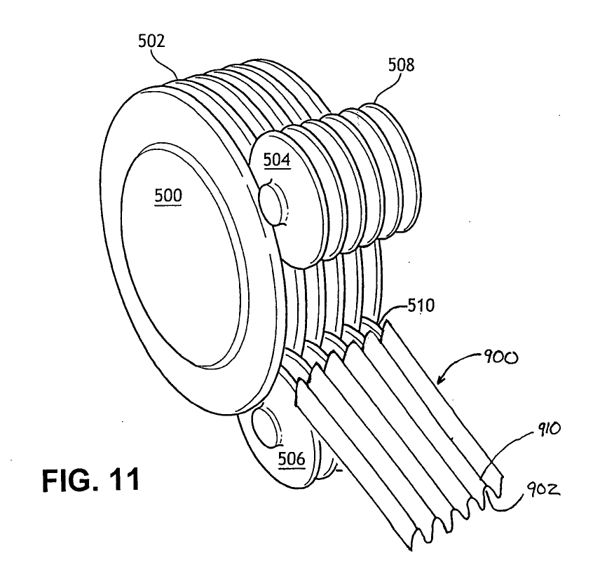

The material can be necked by putting the web under increased machine-direction tension. In addition, or alternatively, a corrugated feed sheet 900 as shown in FIG. 11 could be used. Such a feed sheet 900 would have ridges 902 that are aligned with the grooves of the corresponding grooves of the anvil roll 500 and the satellite rolls. As shown in FIG. 11, the sheet would pass over the feed sheet 900 into the deformation nip formed by the anvil roll 500 and the satellite roll 506, around the anvil roll 500, and finally, through the nip formed by the anvil roll 500 and the satellite roll 504. A nonwoven web passing over the feed sheet 900 will be conformed to the sheet and fed to the grooves of the grooved rolls. As discussed above, the web width will be reduced entering in the deformation nip, but that reduced width will be maintained through deformation and lamination even though the material will be incrementally stretched in the cross-machine direction.

Bonding may occur through adhesive bonding, such as through slot or spray adhesive systems, thermal bonding or other bonding means, such as ultrasonic, microwave, extrusion coating, and/or compressive force or energy. An adhesive bonding system 32 is illustrated in FIGS. 1, 3A, 3B, 4, 6A and 6B. Such a system may be a spray or a slot coat adhesive system. Such slot coat adhesive systems are available from the Nordson Corporation, of Lüneburg, Germany. For example, an adhesive applicator die is available from Nordson under the designation BC-62 Porous Coat® model. Such a die may be held on a coating stand such as the NT 1000 series coating stand. It has been found that slot coating adhesive processes provide for more uniform adhesive coverage, over a wide range of adhesive viscosities.

FIGS. 1, 3A, 3B, 4, 6A and 6B all illustrate adhesive being applied to the film component of the laminated before it meets up with the stretched nonwoven web. Alternatively, or in addition, the adhesive can be applied to the stretched nonwoven web while still in contact with the anvil roll after the last deformation nip and prior to the lamination nip.

It has been found that slot coat adhesive processes are the preferred method of bonding as they provide unique attributes over spray adhesive processes. Adhesive is applied to the nonwoven after the nonwoven is grooved (and necked, if necked at all). At this point in the process the grooved nonwoven has a corrugated surface made up of a series of alternating surface contacting peaks 520 and recessed troughs 540 between the peaks. When spray adhesive is applied to such a grooved nonwoven, the placement of the adhesive is generally uniform throughout the surface of the nonwoven. When such a nonwoven is attached to a polymeric film in a nip the entire surface of the grooved nonwoven, both peaks and troughs, tends to bond with the film. The resulting laminate has a very low level of extensibility and low bulk.

Alternately, when slot coat adhesive processes are used, the adhesive is placed at discrete points on the grooved nonwoven web 50. The adhesive 36 is placed on the peaks 520 of the grooved nonwoven 50 and not in the troughs 540. Generally, a slot coat adhesive process produces a continuous thin film of adhesive. However, when a grooved nonwoven, having peaks and troughs, is passed by the die tip of the slot coat apparatus, the adhesive undergoes a stick-attenuate/break-truncate phenomenon. The adhesive wets and bonds to the peaks of the passing grooved nonwoven web and then is stretched and thinned until the adhesive cohesively fails. The adhesive is broken into discrete portions of adhesive that remain on the peaks of the grooved nonwoven. The slot coat adhesive is not applied to the troughs of the grooved nonwoven. When the grooved nonwoven with slot coat adhesive is bonded to a polymeric film, the bonding occurs merely between the film 10b and the discrete points where the grooved nonwoven 50 meets the film 10b. The extensibility of such a laminate made with slot coat adhesive is greater than that of a similar laminate made with spray adhesive. Because bonding only occurs at discrete points, the grooved nonwoven of the laminate has some amount of free travel, namely the length of nonwoven web between bond points. This free travel allows the laminate to extend at the tension required to extend the film alone for a distance until the grooved nonwoven web is fully extended between the discrete bond points. This allows for a higher extension at lower tensions than current laminates using spray adhesive.

The same effect would be found for a stretchable nonwoven laminate that uses a stretchable film rather than an extensible film

The placement of the adhesive on the discrete peaks of the grooved nonwoven is controllable by optimizing the adhesive characteristics, adhesive temperature, amount of adhesive used, nip pressure and degree of processing of the grooved nonwoven. The slot coat process will tend to place the adhesive on the peaks of the grooved laminate but controlling the adhesive by these variables will insure that the adhesive will stay primarily on the peaks throughout processing of the laminate. The optimized adhesive will have optimized characteristics, including melt temperature, rheology, and open time, such that adhesive will stay placed on the peaks rather than flow from the peaks and into the troughs of the grooved nonwoven.

The nip pressure used to laminate the grooved nonwoven with slot coat adhesive to the polymeric film will also determine the ability to bond in only discrete points. If too much nip pressure is used, the adhesive will be squeezed from the peaks of the grooved nonwoven through the nonwoven and into the troughs of the same nonwoven. The higher the nip pressure, the greater degree that adhesive will be forced from the peaks of the grooved nonwoven to other portions of the grooved nonwoven. Alternately, if too little nip pressure is used there can be inadequate bonding between the polymeric film and the grooved nonwoven. Lower nip pressure can be balanced by adhesive formulation with higher tackiness.

In a similar way the degree of processing will also affect the placement of the adhesive. When the grooved nonwoven and/or laminate undergo a higher degree of processing before the adhesive has fully set, the adhesive will be caused to flow from its placement on the peaks. Again the formulation of the adhesive can be balanced against the degree of processing by providing a formulation that will set up to an appropriate level relative to the processing being used. This would likely require an adhesive that has a shorter open time when dealing with higher machine speeds or more tortuous machine paths for the laminate.

The placement of the adhesive on peaks of the grooved nonwoven and subsequently bonding the grooved nonwoven to a polymeric film only at those discrete points allows for reduced adhesive requirements and lower laminate costs. As discussed above, slot coat adhesive processes place the adhesive only on the peaks of the grooved nonwoven as opposed to the entire surface of a non-grooved nonwoven. When using the same rate of adhesive application via the slot coat process, a simple mass balance reveals that the peaks of grooved nonwoven will have a greater incremental amount of adhesive than the same area would have if it were a non-grooved nonwoven. Effectively, the adhesive that would normally be present in the troughs of the grooved nonwoven is remaining on the peaks.

This additional amount of adhesive on the peaks of the grooved nonwoven is more than is necessary to make a secure bond between the polymeric film and the grooved nonwoven. As discussed above, using more adhesive than needed to bond the nonwoven to the polymeric film will tend to create a situation where the excessive adhesive will try to flow from the peaks to other portions of the grooved nonwoven. Therefore, less adhesive is required for an adequate bond and less is desired in order to keep the adhesive on the peaks of the nonwoven. The use of less adhesive means that overall adhesive used in the laminate will be reduced along with corresponding laminate material costs.

The adhesive used in the present invention must be suitable for slot coat adhesive processes and must be able to bond the flexible sheet materials. It is also desired that the adhesive maintain the bond when the laminate is extended or stretched in use. Examples of suitable adhesives that may be used in the practice of the invention include Rextac 2730, 2723 available from Huntsman Polymers of Houston, Tex., as well as adhesives available from Bostik Findley, Inc, of Wauwatosa, Wis., such as H9375-01.

Alternatively to spraying or slot coating an adhesive on the film or nonwoven layers of the laminate, bonding agents may be incorporated into the film itself. By adding a bonding agent to the film polymer blend in a specified range, the film and nonwoven can be thermally bonded at lower temperatures and/or with lower pressures than without such agents. Bonding agents can also be referred to as tackifying resins and are discussed in U.S. Pat. No. 4,789,699 to Kieffer et al. and U.S. Pat. Nos. 5,695,868 and 5,855,999 to McCormack, the contents of each which is incorporated herein by reference in its entirety.

Rather than incorporating the bonding agent into the film, a thin bonding layer may be coextruded as one or both sides of the film. Such a bonding layer is discussed in U.S. Pat. No. 5,997,981 to McCormack et al., the contents of which is incorporated herein by reference in its entirety.

The inventive extensible or stretchable laminate may be incorporated in numerous personal care products. For instance, such material is particularly advantageous as a stretchable outer cover for various personal care products. Additionally, such film laminate may be incorporated as a base fabric material in protective garments such as surgical or hospital drapes. In still a further alternative embodiment, such material may serve as base fabric for protective recreational covers such as car covers and the like.

1. A method of producing a stretchable laminate, comprising the steps of:
a. providing a first web, having a width
b. providing a second web;
c. providing a first deforming nip, where the first deforming nip comprises a first roll and a second roll;
d. providing a laminating nip, where the laminating nip comprises a third roll and the second roll;
e. supplying the first web into the first deforming nip;
f. deforming the first web across its width, without reduction of the width, by stretching said first web while contacting the second roll;
g. supplying the deformed first web into the laminating nip;
h. supplying the second web to the laminating nip; and
i. joining the second web to the first web in the laminating nip.

2. The method of claim 1 further comprising, heating the first and second rolls.

3. The method of claim 1 further comprising, heating the third roll.

4. The method of claim 1 further comprising, heating the first web prior to supplying the first web to the deformation nip.

5. The method of claim 1 where the first web is a nonwoven material or an absorbent material.

6. The method of claim 5 where the first web is a spunbond material.

7. The method of claim 1 where the second web is an elastic film or an elastic nonwoven material.

8. The method of claim 1 where the second web is a film with a WVTR of about, or greater than, 300 g/m²/24 hours.

9. The method of claim 1 where the second web has multidirectional stretch properties.

10. The method of claim 9, further comprising stretching the second web before laminating the second web to the first web.

11. The method of claim 1 where the first and second rolls are an intermeshed pair of groove rolls.

12. The method of claim 1 where the third roll has a steel surface.

13. The method of claim 1 where the third roll has a deformable surface.

14. The method of claim 13 where the third roll has a rubber surface.

15. The method of claim 1 where the third roll is patterned.

16. The method of claim 1 further comprising the steps of:
a. providing a third web, having a width;
b. providing a second deforming nip, where the second deforming nip comprises a fourth roll and the third roll;
c. supplying the third web into the second deforming nip;
d. deforming the third web across its width, without reduction of the width, by stretching said third web while contacting the third roll;
e. supplying the deformed third web into the laminating nip;
f. joining the third web to the first web and the second web in the laminating nip.

17. The method of claim 16 further comprising, heating the second and third rolls.

18. The method of claim 16 further comprising, heating the first and fourth rolls.

19. The method of claim 16 further comprising, heating the third web prior to supplying the third web to the second deforming nip.

20. The method of claim 16 where the third and forth rolls are an intermeshed pair of groove rolls.

21. The method of claim 16 where the joining of the first and third webs to the second web is accomplished using ultrasonic bonding.

22. An apparatus for producing stretchable laminates, the apparatus comprising:
a first roll;
a second roll;
and a third roll;
where the first roll is a grooved roll, the second roll is a grooved roll, and the first roll is intermeshed with the second roll to form a first deformation nip;
and where the third roll is in proximity to the second roll to form a laminating nip such that material that passes through and is deformed by the first deformation nip maintains its deformation as it subsequently passes through the lamination nip.

23. The apparatus of claim 22 where the first and second rolls are heated.

24. The apparatus of claim 22 where the third roll is heated.

25. The apparatus of claim 22 where the third roll has a steel surface.

26. The apparatus of claim 22 where the third roll has a deformable surface.

27. The apparatus of claim 26 where the third roll has a rubber surface.

28. The apparatus of claim 22 where the third roll is patterned.

29. The apparatus of claim 22 further comprising a fourth roll;
where the third roll is a grooved roll, the fourth roll is a grooved roll, and the third roll is intermeshed with the fourth roll to form a second deformation nip;
and where the third and fourth rolls are in proximity to the second roll such that material that passes through and is deformed by the second deformation nip maintains its deformation as it subsequently passes through the lamination nip.

30. The apparatus of claim 29, where the second and third rolls are capable of ultrasonic bonding.

31. The apparatus of claim 29, where the second and third rolls are heated.

32. The apparatus of claim 29, where the first and fourth rolls are heated.
